(19) United States
(12) Patent Application Publication
(10) Pub. No.: US 2012/0005475 A1
(43) Pub. Date: Jan. 5, 2012

(54) Terminal Device, Computer Program Product, and Communication Control Method

(75) Inventor: Tomohiro INAGAKI, Nagoya-shi (JP)

(73) Assignee: BROTHER KOGYO KABUSHIKI KAISHA, Nagoya-shi (JP)

(21) Appl. No.: 13/234,722

(22) Filed: Sep. 16, 2011

Related U.S. Application Data
(63) Continuation-in-part of application No. PCT/JP2010/053297, filed on Mar. 2, 2010.

(30) Foreign Application Priority Data
Mar. 18, 2009 (JP) 2009-065674

(51) Int. Cl. H04L 9/00

(52) U.S. Cl. 713/150

(57) ABSTRACT

A terminal device capable of communication with a plurality of other terminal devices via a network includes a decryption information acquisition portion that acquires decryption information including a decryption level, an encryption information acquisition portion that acquires encryption information including an encryption level in a case where a pointer position is located within a confidential area, a first transmission portion that transmits the encryption information to the plurality of other terminal devices in a case where the decryption level is equal to or higher than the encryption level, an encryption portion that, based on the encryption level, encrypts audio data and video data that have been input in a case where the pointer position is located within the confidential area, and a second transmission portion that transmits, as encrypted data, the audio data and the video data that have been encrypted to the plurality of other terminal devices.

### CROSS-REFERENCE TO RELATED APPLICATION

This application is a continuation-in-part of International Application No. PCT/JP2010/053297, filed Mar. 2, 2010, which claims priority from Japanese Patent Application No. 2009-065674, filed on Mar. 18, 2009. The disclosure of the foregoing application is hereby incorporated by reference in its entirety.

### BACKGROUND

The present disclosure relates to a terminal device, a computer program product, and a communication control method. Specifically, the present disclosure relates to a terminal device, a computer program product, and a communication control method that enable performing a confidential conference.

A communication conference device is known that is connectable to a plurality of communication conference devices via a network and that can perform a communication conference while sharing a same document image with the plurality of communication conference devices. In this type of communication conference device, when a document image to be shared is transmitted to another communication conference device, an area to be hidden in the document image can be encrypted and the encrypted area can be transmitted together with a password that can decrypt the encrypted area. The communication conference device that has received the document image can decrypt the encrypted area when the password is input. In a case where the document image includes information to be disclosed to a particular partner only, the same document image in which the corresponding information part is encrypted is transmitted to each of the communication conference devices, and the password is notified only to a particular communication conference device. Thus, there is no need to create and transmit a document image separately for each of the communication conference devices. Therefore, it is possible to facilitate operations for document image transmission.

### SUMMARY

The above-described known communication conference device makes it possible to display a document image to be shared in a communication conference on a particular communication conference device only. However, it is necessary to transmit video data to be viewed and audio data to be listened to by a user, after identifying the communication conference device to which the video data and the audio data are to be transmitted. Therefore, a confidential conference may not be smoothly performed during the communication conference.

Various embodiments of the broad principles derived herein provide a terminal device, a computer program product, and a communication control method that enable smoothly performing a confidential conference in a communication conference.

Embodiments provide a terminal device capable of communication with a plurality of other terminal devices via a network. The terminal device includes a decryption information acquisition portion that acquires decryption information that is information to decrypt confidential data that is partially encrypted data in shared data, the shared data being data to be shared with the plurality of other terminal devices and being to be displayed on a display screen that displays information, the decryption information including a decryption level that is a level at which the confidential data can be decrypted and that is determined for each terminal device, and an encryption information acquisition portion that acquires encryption information including an encryption level in a case where a pointer position is located within a confidential area that is an area in which the confidential data is displayed. The encryption level is a level of encryption that has been used for encrypting the confidential data being displayed in the confidential area. The pointer position is a position that is identified by position information of a pointer that is displayed on the display screen based on input information from a pointing device. The terminal device also includes a first transmission portion that transmits the encryption information to the plurality of other terminal devices in a case where the decryption level of the decryption information that has been acquired by the decryption information acquisition portion is equal to or higher than the encryption level of the encryption information that has been acquired by the encryption information acquisition portion, an encryption portion that, based on the encryption level of the encryption information, encrypts audio data and video data that have been input in a case where the pointer position is located within the confidential area, and a second transmission portion that transmits, as encrypted data, the audio data and the video data that have been encrypted by the encryption portion to the plurality of other terminal devices.

Embodiments also provide a computer program product stored on a non-transitory computer-readable medium. The computer program product includes instructions for causing a computer of a terminal device capable of communication with a plurality of other terminal devices via a network to execute the steps of acquiring decryption information that is information to decrypt confidential data that is partially encrypted data in shared data, the shared data being data to be shared with the plurality of other terminal devices and being to be displayed on a display screen that displays information, the decryption information including a decryption level that is a level at which the confidential data can be decrypted and that is determined for each terminal device, acquiring encryption information including an encryption level in a case where a pointer position is located within a confidential area that is an area in which the confidential data is displayed, the encryption level being a level of encryption that has been used for encrypting the confidential data being displayed in the confidential area, and the pointer position being a position that is identified by position information of a pointer that is displayed on the display screen based on input information from a pointing device, transmitting the encryption information to the plurality of other terminal devices in a case where the decryption level of the decryption information that has been acquired is equal to or higher than the encryption level of the encryption information that has been acquired, encrypting, based on the encryption level of the encryption information, audio data and video data that have been input in a case where the pointer position is located within the confidential area, and transmitting, as encrypted data, the audio data and the video data that have been encrypted to the plurality of other terminal devices.

Embodiments further provide a communication control method performed by a terminal device capable of communication with a plurality of other terminal devices via a network. The method includes the steps of acquiring decryption information that is information to decrypt confidential data that is partially encrypted data in shared data, the shared data being data to be shared with the plurality of other terminal devices and being to be displayed on a display screen that displays information, the decryption information including a decryption level that is a level at which the confidential data can be decrypted and that is determined for each terminal device, acquiring encryption information including an encryption level in a case where a pointer position is located within a confidential area that is an area in which the confidential data is displayed, the encryption level being a level of encryption that has been used for encrypting the confidential data being displayed in the confidential area, and the pointer position being a position that is identified by position information of a pointer that is displayed on the display screen based on input information from a pointing device, transmitting the encryption information to the plurality of other terminal devices in a case where the decryption level of the decryption information that has been acquired is equal to or higher than the encryption level of the encryption information that has been acquired, encrypting, based on the encryption level of the encryption information, audio data and video data that have been input in a case where the pointer position is located within the confidential area, and transmitting, as encrypted data, the audio data and the video data that have been encrypted to the plurality of other terminal devices.

### BRIEF DESCRIPTION OF THE DRAWINGS

Embodiments will be described below in detail with reference to the accompanying drawings in which:

FIG. 1 is a diagram showing an example of topology of a communication control system;

FIG. 2 is a block diagram showing an electrical configuration of a terminal device;

FIG. 3 is a block diagram showing an electrical configuration of a server;

FIG. 4 is a schematic diagram showing a configuration of a conference information table;

FIG. 5 is a diagram showing an example of a video conference screen that is displayed on a monitor;

FIG. 6 is a schematic diagram in a case where image data including confidential areas is generated in shared image data;

FIG. 7 is a diagram showing an example of the video conference screen that is displayed on the monitor;

FIG. 8 is a flowchart of main processing that is performed by the terminal device;

FIG. 9 is a flowchart of confidential conference start processing that is performed in the main processing shown in FIG. 8;

FIG. 10 is a flowchart of encryption information reception processing that is performed in the main processing shown in FIG. 8;

FIG. 11 is a flowchart of data transmission processing that is performed in the main processing shown in FIG. 8;

FIG. 12 is a flowchart of data output processing that is performed in the main processing shown in FIG. 8; and

FIG. 13 is a diagram showing an example of the video conference screen on which confidential conference information is displayed.

### DETAILED DESCRIPTION

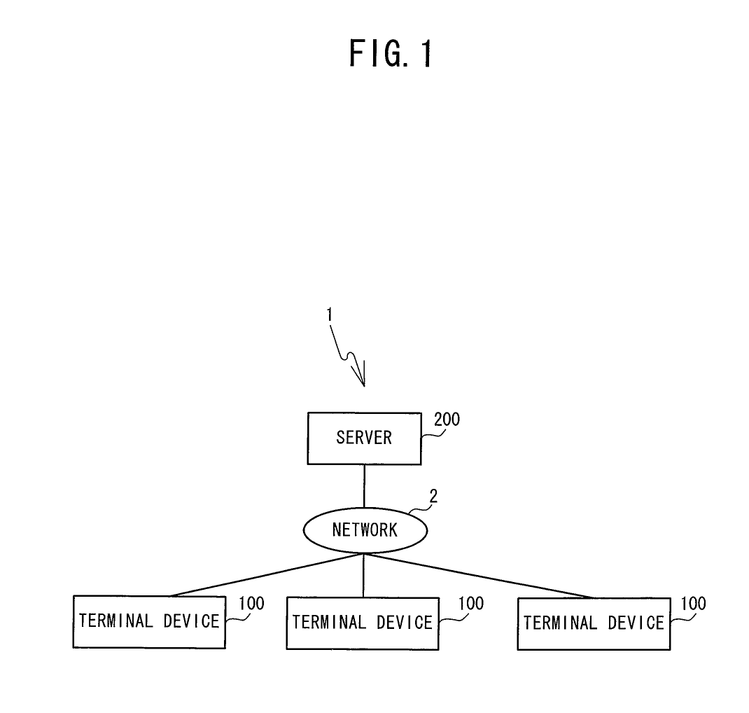

A communication control system 1 according to an embodiment of the present disclosure will be described below with reference to the appended drawings. First, an overview of the communication control system 1 will be described with reference to FIG. 1.

In the communication control system 1, a plurality of terminal devices 100 are connected to a server 200 via a network 2 as shown in FIG. 1. Image data and audio data are mutually transmitted and received between the terminal devices 100 so that a video conference may be performed. FIG. 1 shows three of the terminal devices 100. It is sufficient if a conference can be performed such that the audio data and the image data are not disclosed to a particular one of a plurality of terminal devices 100 that transmit and receive the audio data and the image data via the network 2. Accordingly, the number of the connected terminal devices 100 may be at least three. A conference in which audio data and image data are not disclosed to a particular one of the terminal devices 100 is hereinafter referred to as a “confidential conference”. The plurality of terminal devices 100 may exist in, for example, the same site of a company. The plurality of terminal devices 100 may be scattered in different business locations, different regions, or different countries.

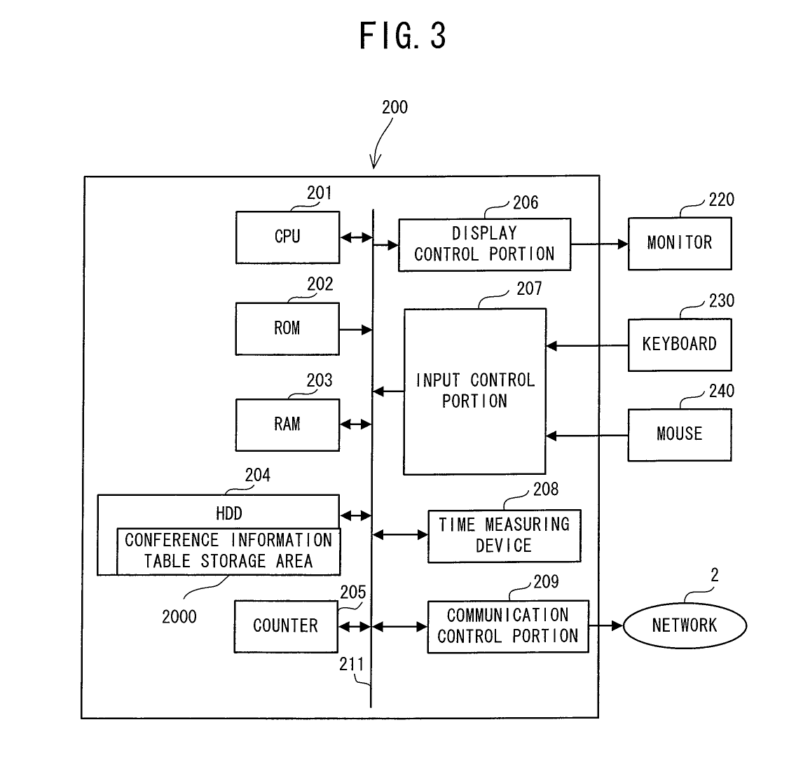

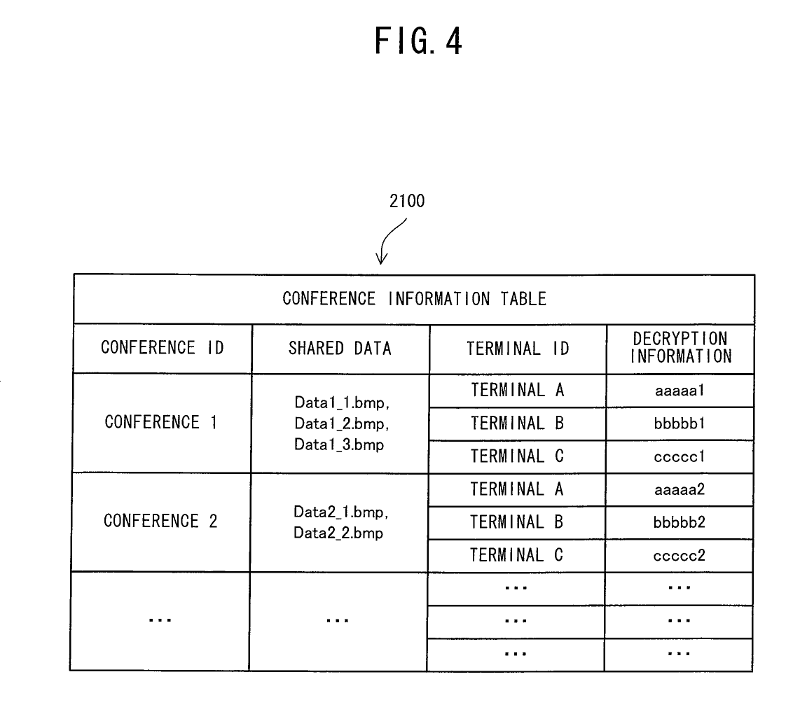

The terminal devices 100 may be, for example, known personal computers and are general-purpose devices. The server 200 may be, for example, a known personal computer and is a general-purpose device. A conference information table 2100 (refer to FIG. 4) may be stored in a hard disk drive (HDD) 204 (refer to FIG. 3) of the server 200. The conference information table 2100 includes information to decrypt audio data or image data that has been encrypted and that is to be used in a video conference, for each of the terminal devices 100 that perform communication in the video conference. Data that has been encrypted is hereinafter referred to as “encrypted data”. Information to decrypt the encrypted data is hereinafter referred to as “decryption information”. The server 200 may be accessed from each of the terminal devices 100 when a video conference is performed, and the server 200 may transmit to each of the terminal devices 100 the decryption information that corresponds to each of the terminal devices 100. The conference information table 2100 will be described in more detail below.

In the present embodiment, a known secret key cryptosystem, whose processing speed is relatively high, may be used as a technique to encrypt data. A known Data Encryption Standard (DES) or a triple DES, for example, may be used as an algorithm that is used in the secret key cryptosystem. When encrypted data is generated, data may be encrypted based on information (hereinafter referred to as “encryption information”) that is used for encryption and on a level (hereinafter referred to as an “encryption level”) that is included in the encryption information. The encrypted data may be decrypted based on the decryption information that is determined in advance for each of the terminal devices 100 and on a level that is included in the decryption information. The level that is included in the decryption information is hereinafter referred to as a “decryption level”.

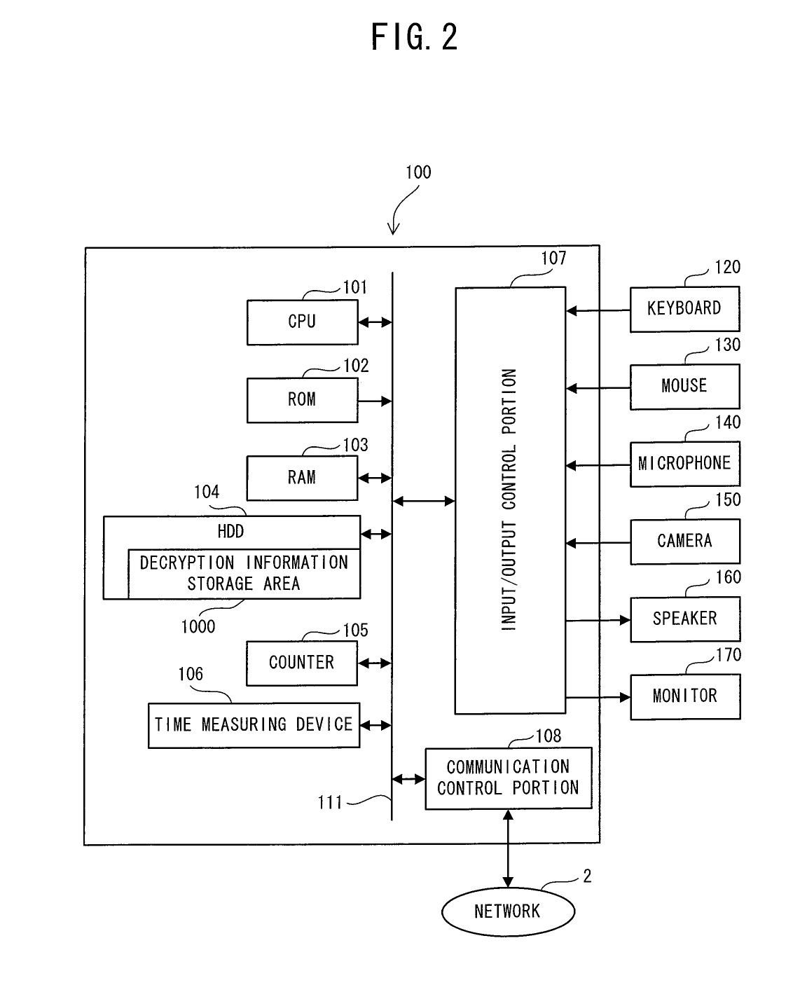

An electrical configuration of the terminal device 100 will be described with reference to a block diagram shown in FIG. 2. As shown in FIG. 2, the terminal device 100 includes a CPU 101, which controls the terminal device 100. A ROM 102, a RAM 103, a hard disk drive (HDD) 104, a counter 105, a time measuring device 106, an input/output control portion 107, and a communication control portion 108 are connected to the CPU 101 via a bus 111. The CPU 101 constitutes a computer that controls the terminal device 100, together with the ROM 102, the RAM 103, the HDD 104, and the like.

The ROM 102 may store a program that activates a basic input/output system (BIOS), which may be executed by the CPU 101, and set values. The RAM 103 may temporarily store various types of data. The HDD 104 may store various types of programs etc., which may be executed by the terminal device 100. The HDD 104 includes a decryption information storage area 1000. The decryption information, which is used for decrypting the data received from another terminal device 100, may be stored in the decryption information storage area 1000. The counter 105 functions as a timer and may measure time. The time measuring device 106 may measure time as an internal clock.

A keyboard 120, a mouse 130, a microphone 140, a camera 150, a speaker 160, and a monitor 170 are connected to the input/output control portion 107. The keyboard 120 and the mouse 130 may be used when a user performs an input operation. The mouse 130 is a type of pointing device. The microphone 140 may be used for acquiring audio spoken by the user. The camera 150 may be used for acquiring an image that is to be used in a video conference. The speaker 160 may be used for outputting audio data transmitted from another terminal device 100 when the video conference is being performed. Image data transmitted from another terminal device 100 may be displayed on the monitor 170. The communication control portion 108 may control transmission and reception of data to and from the other terminal devices 100 via the network 2.

An electrical configuration of the server 200 will be described with reference to a block diagram shown in FIG. 3. As shown in FIG. 3, the server 200 includes a CPU 201, which controls the server 200. A ROM 202, a RAM 203, the HDD 204, a counter 205, a display control portion 206, an input control portion 207, a time measuring device 208, and a communication control portion 209 are connected to the CPU 201 via a bus 211.

The ROM 202 may store a program that activates a BIOS executed by the CPU 201 and set values. The RAM 203 may temporarily store various types of data. The HDD 204 may store various types of programs etc. executed by the server 200. The HDD 204 includes a conference information table storage area 2000. The conference information table 2100 (refer to FIG. 4) may be stored in the conference information table storage area 2000. The counter 205 functions as a timer and may measure time.

A monitor 220 is connected to the display control portion 206. Information may be displayed on the monitor 220. A keyboard 230 and a mouse 240 are connected to the input control portion 207. The keyboard 230 and the mouse 240 may be used when a user performs an input operation. The time measuring device 208 may measure time as an internal clock. The communication control portion 209 may control transmission and reception of data to and from the terminal devices 100 via the network 2.

The conference information table 2100 will be described with reference to FIG. 4. The conference information table 2100 may be registered on the server 200 by a representative of users who attend the video conference, from the terminal device 100 via the network 2, in advance before a video conference is performed.

The conference information table 2100 includes a conference ID field, a shared data field, a terminal ID field, and a decryption information field. Information that identifies a video conference is stored in the conference ID field. The information that identifies a video conference is hereinafter referred to as a “conference ID”. A file name of image data for an agenda etc. that is to be shared between the terminal devices 100 and that is to be displayed in the video conference is stored in the shared data field. The image data that is to be shared and displayed is hereinafter referred to as “shared data”. Information that identifies the terminal devices 100 used by the users who attend the video conference is stored in the terminal ID field. The information that identifies the terminal devices 100 is hereinafter referred to as “terminal IDs”. Decryption information that is to be used in the terminal devices 100 identified by each of the terminal IDs in the video conference is stored in the decryption information field. For example, file names of shared data pieces that are to be used in the video conference identified by the conference ID “Conference 1” are “Data1_1.bmp”, “Data1_2.bmp”, and “Data1_3.bmp”. Terminal IDs of terminal devices 100 used by users who attend the video conference with the conference ID “Conference 1” are “Terminal A”, “Terminal B”, and “Terminal C”. Decryption information associated with the conference ID “Conference 1” and the terminal ID “Terminal A” is “aaaaa1”. Decryption information associated with the conference ID “Conference 1” and the terminal ID “Terminal B” is “bbbbb1”. Decryption information associated with the conference ID “Conference 1” and the terminal ID “Terminal C” is “ccccc1”.

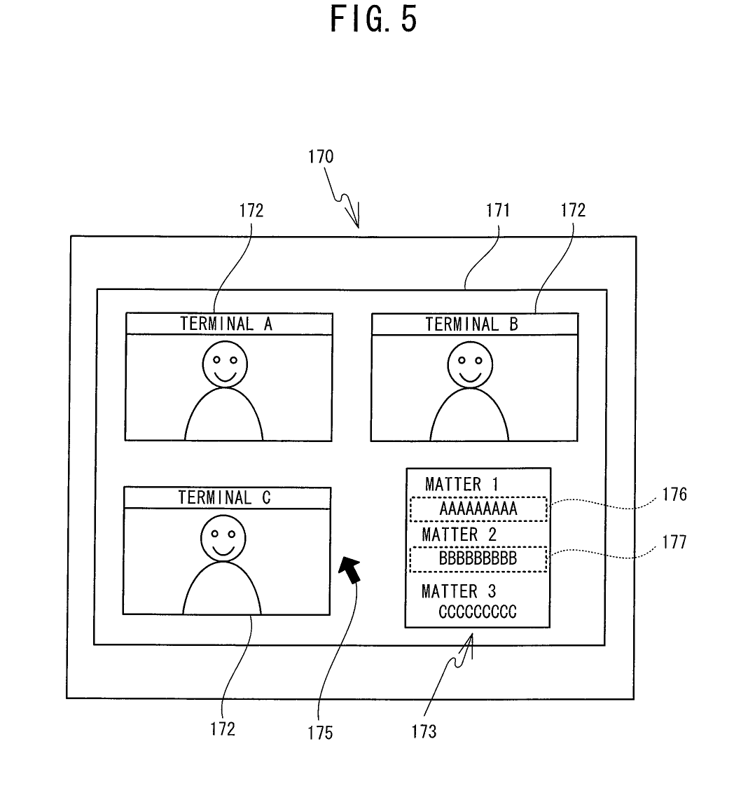

A video conference screen 171 displayed on the monitor 170 that is connected to the terminal device 100 will be described with reference to FIG. 5.

When a video conference is held, the video conference screen 171 such as that shown in FIG. 5 may be displayed on the monitor 170 of the terminal device 100. The video conference screen 171 includes individual areas 172 for the respective terminal devices 100. Image data that is captured by the camera 150 of each of the terminal devices 100 may be displayed on each of the individual areas 172. An up-down direction and a left-right direction of the page of FIG. 5 are referred to as an up-down direction and a left-right direction of the video conference screen 171.

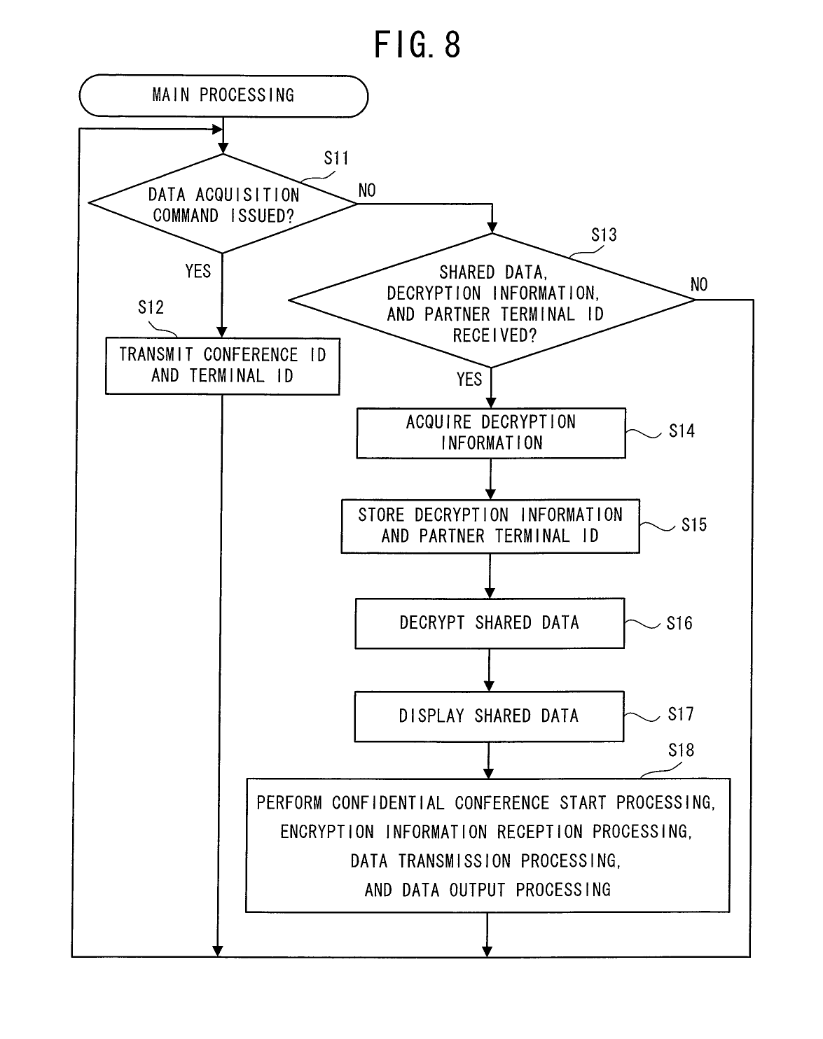

A rectangular-shaped shared display area 173 is provided on the video conference screen 171. When the video conference is held, the shared data may be displayed in the shared display area 173. When main processing (refer to FIG. 8) is performed and a data acquisition command is issued, each of the terminal devices 100 may access the server 200 and may acquire the shared data from the server 200. Then, the acquired shared data may be displayed in the shared display area 173. The shared display area 173 may be fixed on the video conference screen 171, and may be defined in advance based on relative coordinates from a reference point of the video conference screen 171. For example, it is assumed that the reference point is an upper left corner of the video conference screen 171 shown in FIG. 5, and relative coordinates of each corner of the rectangular-shaped shared display area 173 are defined. Here, a rightward direction from the reference point of the video conference screen 171 is defined as a positive direction of an X axis, and a downward direction from the reference point is defined as a positive direction of a Y axis.

In the shared data that is to be displayed in the shared display area 173, an area to be kept secret from a particular one of the terminal devices 100 may be specified by the representative in advance. An area to be kept secret is hereinafter referred to as a “confidential area”. Image data for each specified confidential area may be encrypted based on an encryption level.

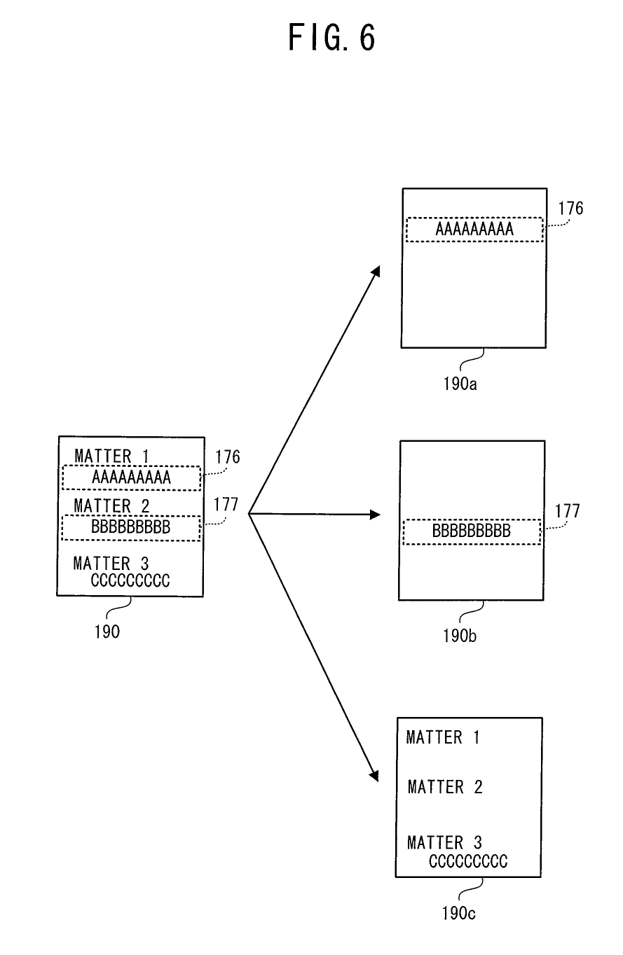

For example, as shown in FIG. 6, when confidential areas 176 and 177 are specified in shared image data 190 that is generated in the terminal device 100 used by the representative of the video conference, image data to be transmitted to the server 200 is generated. Specifically, image data pieces 190a and 190b are generated by extracting parts corresponding to the confidential areas 176 and 177, respectively. Then, an exclusive OR operation between pixels is performed between the original shared image data piece 190 and the extracted image data pieces (hereinafter also referred to as “confidential data pieces”) 190a and 190b, and an image data piece 190c, in which the confidential areas 176 and 177 have been deleted, is generated. The exclusive OR operation is a basic type of logical operation, and can output only a part that does not match input information.

In the above-described example, the image data pieces 190a to 190c are image data pieces to be transmitted, as shared data, from the server 200 to the other terminal devices 100. At this time, information of coordinate values that identify the confidential areas 176 and 177 and encryption information are added to the image data pieces 190a and 190b including the confidential areas 176 and 177, respectively, and the image data pieces 190a and 190b are transmitted. Information of coordinate values that identify a confidential area is hereinafter referred to as “confidential area information”. The encryption information also includes an encryption level. The coordinates of four corners of the confidential area are defined by relative coordinates from a reference position of the image data. Here, the upper left corner of the image data is defined as a reference point, the rightward direction from the reference point is defined as the positive direction of the X axis, and the downward direction from the reference point is defined as the positive direction of the Y axis.

The other terminal devices 100 that have received the image data pieces (190a to 190c) in the above-described example may perform decryption processing on the encrypted image data pieces 190a and 190b, respectively, based on the decryption information acquired from the server 200. The decrypted image data pieces 190a and 190b may be synthesized with the received image data piece 190c, and thus the shared data may be decrypted. Then, the decrypted shared data may be displayed in the shared display area 173.

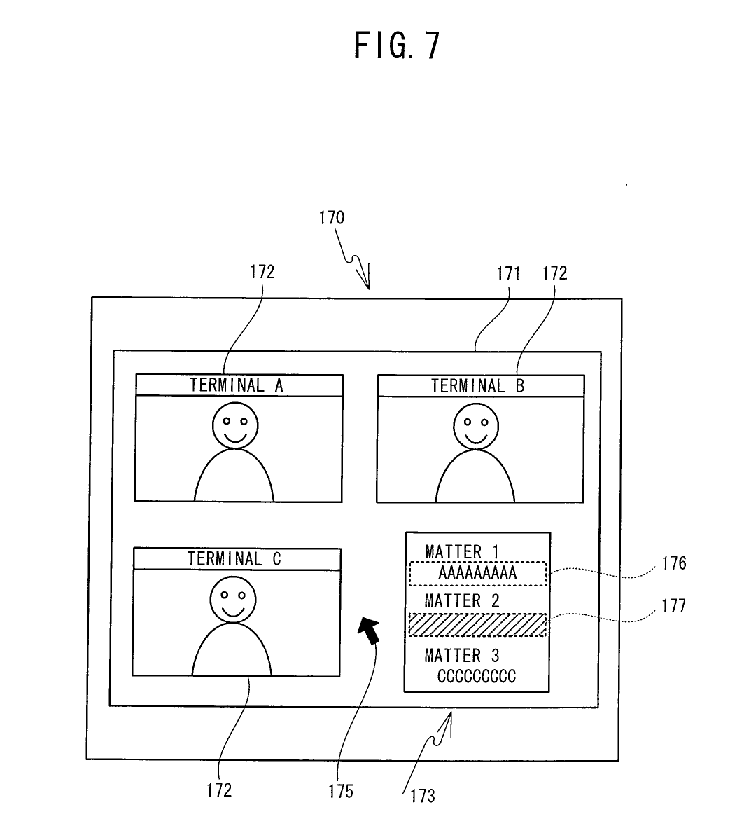

In a case where there is the image data piece (190b) that cannot be decrypted, image data including the confidential area 177 that cannot be decrypted may be generated and the generated image data may be displayed as shared data in the shared display area 173 as shown in FIG. 7.

A mouse cursor image 175 of the terminal device 100 may be displayed on the video conference screen 171. The mouse cursor image 175 is hereinafter referred to as a “cursor image”.

The main processing that is performed by the terminal device 100 will be described with reference to FIG. 8. The main processing shown in FIG. 8 may be performed by the CPU 101 when a video conference application is activated in the terminal device 100. When the video conference application is stopped, the main processing shown in FIG. 8 may automatically end. It is assumed that another processing that is performed by the video conference application may be performed in another process, and an explanation thereof is omitted.

When the main processing shown in FIG. 8 is started, the CPU 101 determines whether a data acquisition command has been issued (step S11). Specifically, it is determined whether a data acquisition button (not shown in the drawings) is specified. The data acquisition button may be displayed on a data acquisition screen (not shown in the drawings) on the monitor 170 that is connected to the terminal device 100. The data acquisition button may be specified for acquiring, from the conference information table 2100 that has been registered in advance in the server 200, the shared data that is to be used in the video conference and the decryption information. Control of the data acquisition button may be made effective when the terminal ID of the terminal device 100 used by the user who attends the video conference and the conference ID of the video conference attended by the user are specified on the data acquisition screen.

If the CPU 101 determines that the data acquisition command has been issued (YES at step S11), namely, if the data acquisition button has been specified, the conference ID and the terminal ID that have been specified on the data acquisition screen are transmitted to the server 200 (step S12). Then, the processing shifts to step S11.

If the CPU 101 determines that the data acquisition command has not been issued (NO at step S11), namely, if the data acquisition button has not been specified, it is determined whether the shared data, the decryption information, and partner terminal IDs have been received from the server 200 (step S13). The partner terminal IDs are terminal IDs that respectively identify the other terminal devices 100 with which communication is performed when the video conference identified by the conference ID transmitted in the processing at step S12 is performed. The shared data, and the decryption information corresponding to the terminal device 100 are information corresponding to the conference ID and the terminal IDs transmitted in the processing at step S12. For example, in a case where the conference information table 2100 stored in the conference information table storage area 2000 of the HDD 204 of the server 200 is the table shown in FIG. 4, and in a case where the conference ID transmitted in the processing at step S12 is “Conference 2” and the terminal ID is “Terminal A”, the shared data received from the server 200 are “Data2_1.bmp” and “Data2_2.bmp”, and the decryption information is “aaaaa2”. The partner terminal IDs are “Terminal B” and “Terminal C”. Thus, the decryption information can be acquired based on the terminal ID, from the conference information table 2100 stored in advance in the conference information table storage area 2000.

If the CPU 101 determines that the shared data, the decryption information, and the partner terminal IDs have not been received (NO at step S13), the processing shifts to step S11. Then, the processing at steps S11 and S13 is performed while the data acquisition command is not issued and the shared data, the decryption information, and the partner terminal IDs are not received.

If the CPU 101 determines that the shared data, the decryption information, and the partner terminal IDs have been received (YES at step S13), namely, if the CPU 101 determines that the shared data and the decryption information corresponding to the conference ID and the terminal IDs transmitted at step S12 have been received from the server 200, the CPU 101 acquires the received decryption information (step S14). Then, the CPU 101 stores the acquired decryption information in the decryption information storage area 1000 of the HDD 104, and stores the received partner terminal ID in a partner terminal ID storage area (not shown in the drawings) of the RAM 103 (step S15).

Next, in a case where the received shared data includes a confidential area, the CPU 101 decrypts the shared data using the acquired decryption information (step S16). Specifically, in a case where the received shared data includes the plurality of image data pieces (190a to 190c) as shown in FIG. 6, the image data pieces may be decrypted by the acquired decryption information. Here, in a case where the decryption level included in the acquired decryption information is equal to or higher than the encryption level included in the encryption information used to encrypt the received image data, the image data is decrypted.

In a case where the received shared data is encrypted data that includes a plurality of image data pieces, the CPU 101 synthesizes the decrypted image data pieces, and displays the synthesized image data as the shared data in the shared display area 173 (step S17). In a case where there is an image data piece that cannot be decrypted, the image data pieces are synthesized while the image data piece that cannot be decrypted is still encrypted. As a result, for example, as shown in FIG. 7, the synthesized image data is displayed in the shared display area 173 such that the image data includes the confidential area 177 corresponding to the image data piece that cannot be decrypted.

In a case where the shared data includes a plurality of image data pieces, the confidential areas corresponding to the received image data pieces and the encryption information are associated with each other and stored in an image data-related information storage area (not shown in the drawings) of the RAM 103. The image data-related information storage area is a shared memory area to share information between different processes.

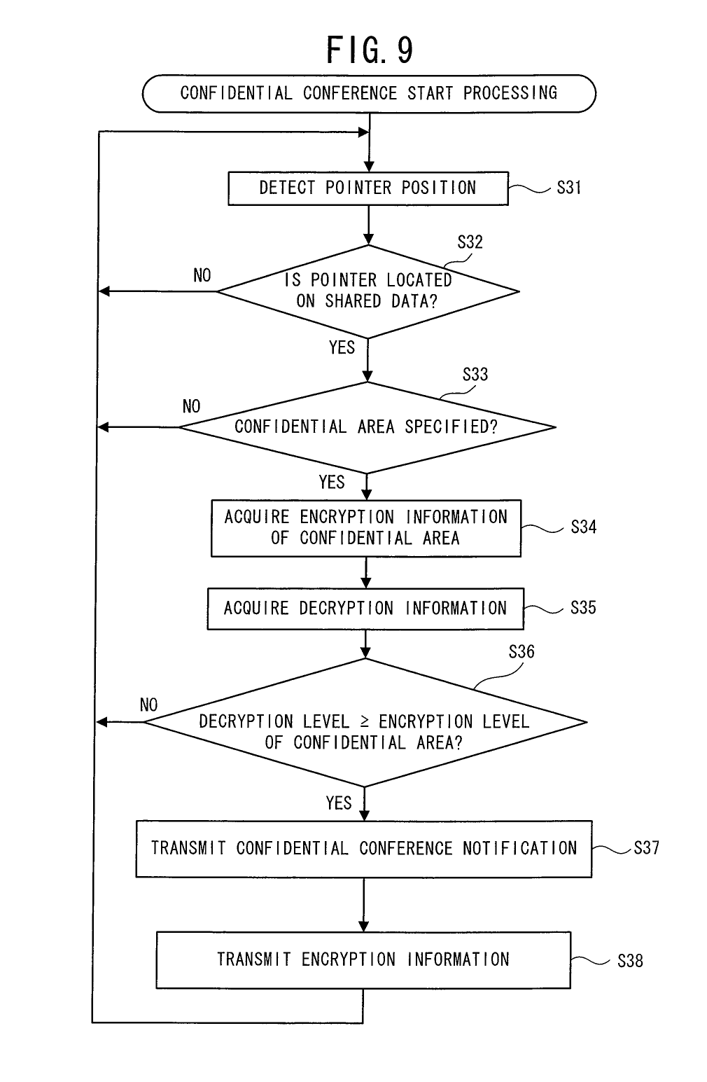

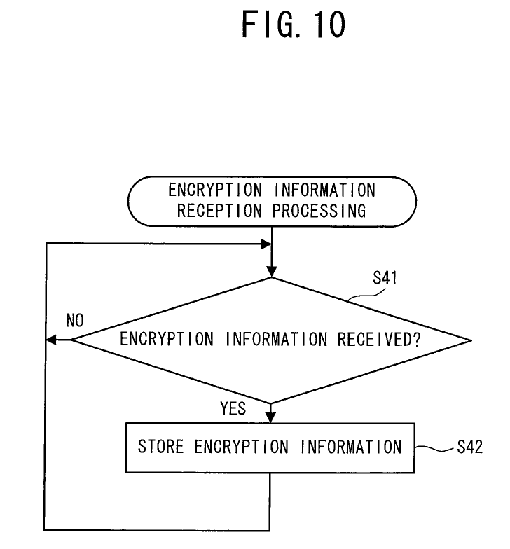

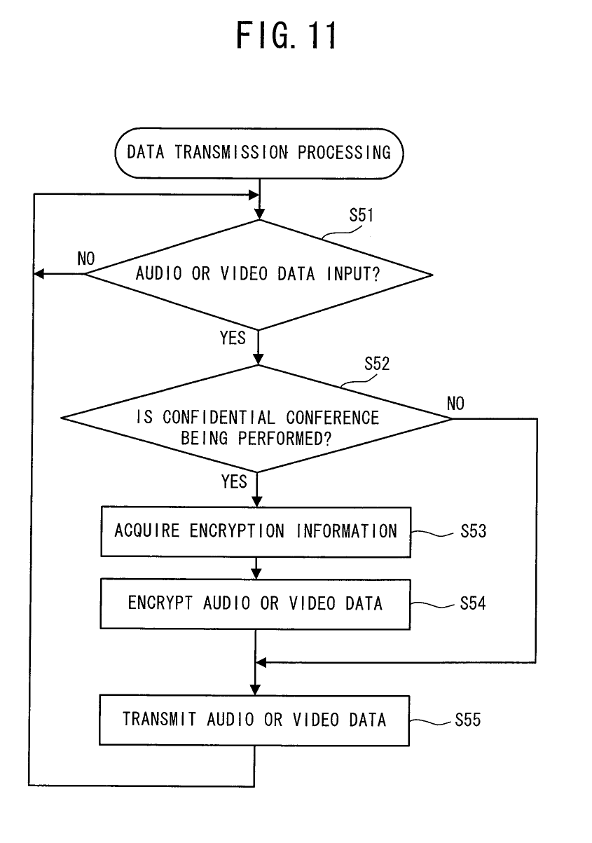

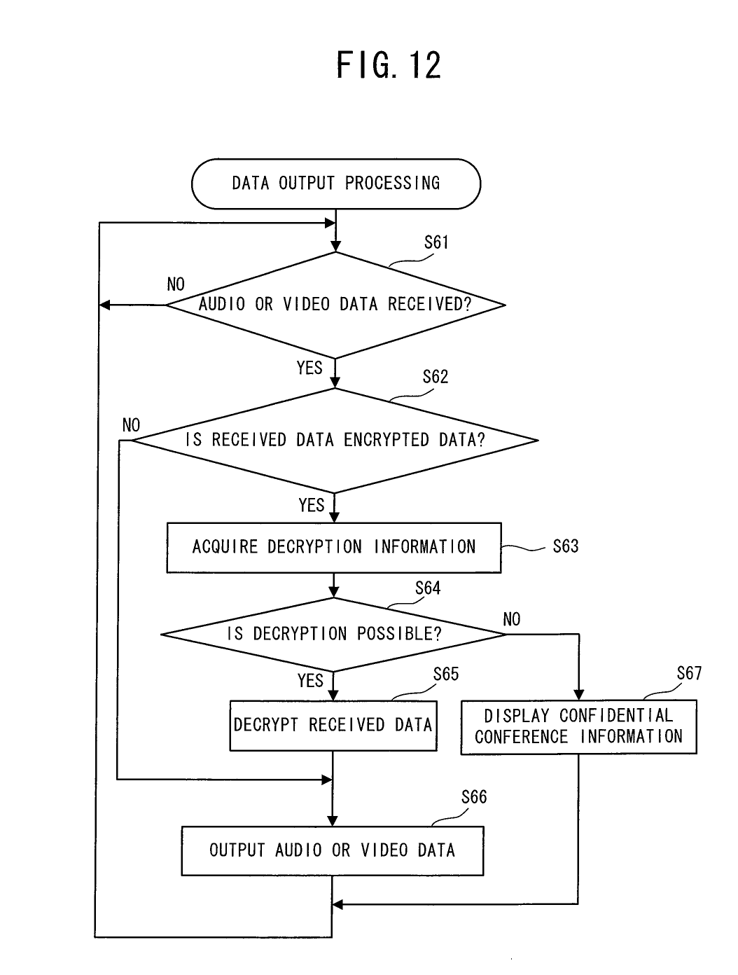

Then, the CPU 101 performs confidential conference start processing (refer to FIG. 9), encryption information reception processing (refer to FIG. 10), data transmission processing (refer to FIG. 11), and data output processing (refer to FIG. 12) (step S18), and the processing shifts to step S11. The confidential conference start processing, the encryption information reception processing, the data transmission processing, and the data output processing may be performed in processes that are activated from the main processing. A process in which the main processing is performed may be a parent process, and the processes in which the confidential conference start processing, the encryption information reception processing, the data transmission processing, and the data output processing are performed may be child processes. These child processes will be described in detail below.

The confidential conference start processing will be described with reference to FIG. 9. The confidential conference start processing may operate as a child process when the processing at step S18 of the main processing shown in FIG. 8 is performed. The confidential conference start processing may automatically end when the main processing shown in FIG. 8 ends.

When the confidential conference start processing is performed, the CPU 101 detects a position of a pointer that is controlled by the mouse 130 (step S31). Here, relative coordinates of the pointer from the reference point on the video conference screen 171 are detected. Then, the CPU 101 determines whether the position of the pointer is located on the shared data (step S32). Specifically, it is determined whether the detected coordinates of the pointer are included within the shared display area 173 in which the shared data is displayed. If the CPU 101 determines that the position of the pointer is not located on the shared data (NO at step S32), namely, if the CPU 101 determines that the coordinates of the pointer are not included within the shared display area 173 in which the shared data is displayed, the processing shifts to step S31.

If the CPU 101 determines that the position of the pointer is located on the shared data (YES at step S32), namely, if the CPU 101 determines that the coordinates of the pointer are included within the shared display area 173 in which the shared data is displayed, the CPU 101 determines whether the confidential area has been specified (step S33). Specifically, this determination is made based on whether the coordinates of the pointer are included within the encrypted confidential area in the image indicated by the shared data displayed in the shared display area 173.

If the CPU 101 determines that the confidential area has not been specified (NO at step S33), namely, if the CPU 101 determines that the coordinates of the pointer are not included within the encrypted confidential area, the processing shifts to step S31.

If the CPU 101 determines that the confidential area has been specified (YES at step S33), namely, if the CPU 101 determines that the coordinates of the pointer are included within the encrypted confidential area, the encryption information of the specified confidential area is acquired (step S34). Specifically, the encryption information corresponding to the specified confidential area is acquired from the image data-related information storage area of the RAM 103. The acquired encryption information is stored in an encryption information storage area (not shown in the drawings) of the RAM 103. The encryption information storage area is a shared memory area to share information between different processes. Next, the CPU 101 acquires the decryption information from the decryption information storage area 1000 of the HDD 104 (step S35).

Next, the CPU 101 determines whether the decryption level is equal to or higher than the encryption level of the confidential area (step S36). The decryption level is included in the decryption information acquired in the processing at step S35. The encryption level is included in the encryption information acquired in the processing at step S34.

If the CPU 101 determines that the decryption level is equal to or higher than the encryption level of the confidential area (YES at step S36), the CPU 101 transmits a confidential conference notification to the other terminal devices 100 with which communication is being performed in the video conference (step S37). The confidential conference notification is information that is transmitted to the other terminal devices 100 in a case where a confidential conference is performed. The other terminal devices 100 to which the confidential conference notification is to be transmitted can be identified by the partner terminal IDs stored in the partner terminal ID storage area of the RAM 103. The terminal device 100 that has received the confidential conference notification stores the confidential conference notification in a confidential conference notification storage area (not shown in the drawings) of the RAM 103. The confidential conference notification is stored also in the confidential conference notification storage area of the terminal device 100 that has transmitted the confidential conference notification. The confidential conference notification storage area is a shared memory area to share information between different processes.

In the terminal device 100 that has transmitted the confidential conference notification, in a case where the position of the pointer controlled by the mouse 130 is moved out of the confidential area specified when transmitting the confidential conference notification, a confidential conference stop signal is transmitted to the other terminal devices 100 identified by the partner terminal IDs. The confidential conference stop signal is information to stop the confidential conference. In the terminal devices 100 that have received the confidential conference stop signal, in a case where the confidential conference notification is stored in the confidential conference notification storage area (not shown in the drawings) of the RAM 103, the confidential conference notification is deleted. Further, if the encryption information is stored in the encryption information storage area of the RAM 103, the encryption information is deleted. Thus, when the user who has started the confidential conference moves the pointer, which is controlled by the mouse 130, out of the confidential area, the confidential conference can be stopped easily.

Next, the CPU 101 transmits the encryption information acquired in the processing at step S34 to the other terminal devices 100 with which communication is performed in the video conference (step S38). The other terminal devices 100 to which the encryption information is to be transmitted is identified by the partner terminal IDs stored in the partner terminal ID storage area of the RAM 103. The encryption information is stored in the encryption information storage area (not shown in the drawings) of the RAM 103 of the terminal device 100 that has transmitted the encryption information. The processing shifts to step S31.

The encryption information reception processing will be described with reference to FIG. 10. The encryption information reception processing shown in FIG. 10 may operate as the child process when the processing at step S18 of the main processing shown in FIG. 8 is performed. The encryption information reception processing may automatically end when the main processing shown in FIG. 8 ends.

When the encryption information reception processing is performed, the CPU 101 determines whether the encryption information has been received (step S41). The encryption information may be transmitted from any one of the other terminal devices 100 in the confidential conference start processing (step S38 in FIG. 9). If the CPU 101 determines that the encryption information has not been received (NO at step S41), the processing at step S41 is repeatedly performed while the encryption information is not received.

If the CPU 101 determines that the encryption information has been received (YES at step S41), the CPU 101 stores the received encryption information in the encryption information storage area of the RAM 103 (step S42). Then, the processing shifts to step S41.

The data transmission processing will be described with reference to FIG. 11. The data transmission processing shown in FIG. 11 may operate as the child process when the processing at step S18 of the main processing shown in FIG. 8 is performed. The data transmission processing may automatically end when the main processing shown in FIG. 8 ends.

When the data transmission processing is performed, the CPU 101 determines whether audio data or video data has been input (step S51). The audio data may be acquired from the microphone 140 of the terminal device 100. The video data may be acquired from the camera 150 of the terminal device 100. If the audio data or the video data has not been input (NO at step S51), the processing at step S51 is repeatedly performed while the audio data or the video data is not input.

If the CPU 101 determines that the audio data or the video data has been input (YES at step S51), the CPU 101 determines whether a confidential conference is being performed (step S52). Specifically, it is determined whether the confidential conference notification is stored in the confidential conference notification storage area of the RAM 103.

If the CPU 101 determines that the confidential conference is being performed (YES at step S52), namely, if the confidential conference notification is stored in the confidential conference notification storage area of the RAM 103, the CPU 101 acquires the encryption information from the encryption information storage area of the RAM 103 (step S53).

Then, the CPU 101 encrypts the audio data or video data that has been acquired, in accordance with the encryption information acquired in the processing at step S53 and the encryption level of the encryption information (step S54). Then, the CPU 101 transmits the audio data or video data that has been encrypted to the other terminal devices 100 with which communication is being performed in the video conference (step S55). The other terminal devices 100 to which the audio data and video data that have been encrypted are to be transmitted is identified by the partner terminal IDs stored in the partner terminal ID storage area of the RAM 103. Then, the processing shifts to step S51.

If the CPU 101 determines that the confidential conference is not being performed (NO at step S52), the input audio data or video data are transmitted to the other terminal devices 100 with which the video conference is being performed (step S55). In other words, if the confidential conference is not being performed, the input audio data or video data are not encrypted and are transmitted to the other terminal devices 100.

The data output processing will be described with reference to FIG. 12. The data output processing shown in FIG. 12 may operate as the child process when the processing at step S18 of the main processing shown in FIG. 8 is performed. The data output processing may automatically end when the main processing shown in FIG. 8 ends.

When the data output processing is performed, the CPU 101 determines whether audio data or video data has been received from any one of the other terminal devices 100 (step S61). The audio data or the video data may be transmitted from the other terminal devices 100 in the processing at step S55 of the data transmission processing shown in FIG. 11. If the CPU 101 determines that the audio data or the video data has not been received from any one of the other terminal devices 100 (NO at step S61), the processing at step S61 is repeatedly performed while the audio data or the video data is not received from the other terminal device 100.

If the CPU 101 determines that the audio data or the video data has been received from any one of the other terminal devices 100 (YES at step S61), the CPU 101 determines whether the received data is encrypted data (step S62). Specifically, it is determined whether the encryption information transmitted from one of the other terminal devices 100 is stored in the encryption information storage area of the RAM 103.

If the CPU 101 determines that the received data is encrypted data (YES at step S62), namely, if the encryption information is stored in the encryption information storage area of the RAM 103, the CPU 101 acquires the decryption information from the decryption information storage area 1000 of the HDD 104 (step S63).

Next, the CPU 101 determines whether the received data can be decrypted (step S64). Specifically, it is determined whether the decryption level of the decryption information acquired in the processing at step S63 is equal to or higher than the encryption level included in the received data. If the CPU 101 determines that the received data can be decrypted (YES at step S64), namely, if the decryption level of the decryption information acquired in the processing at step S63 is equal to or higher than the encryption level included in the received data, the CPU 101 decrypts the received data based on the decryption information (step S65).

Then, the CPU 101 causes the audio data or video data that has been decrypted to be output (step S66). Here, when the audio data is decrypted, the decrypted audio data may be output from the speaker 160 of the terminal device 100. When the video data is decrypted, the decrypted video data may be displayed in the individual area 172 that corresponds to the terminal device 100 that has transmitted the video data. Then, the processing shifts to step S61.

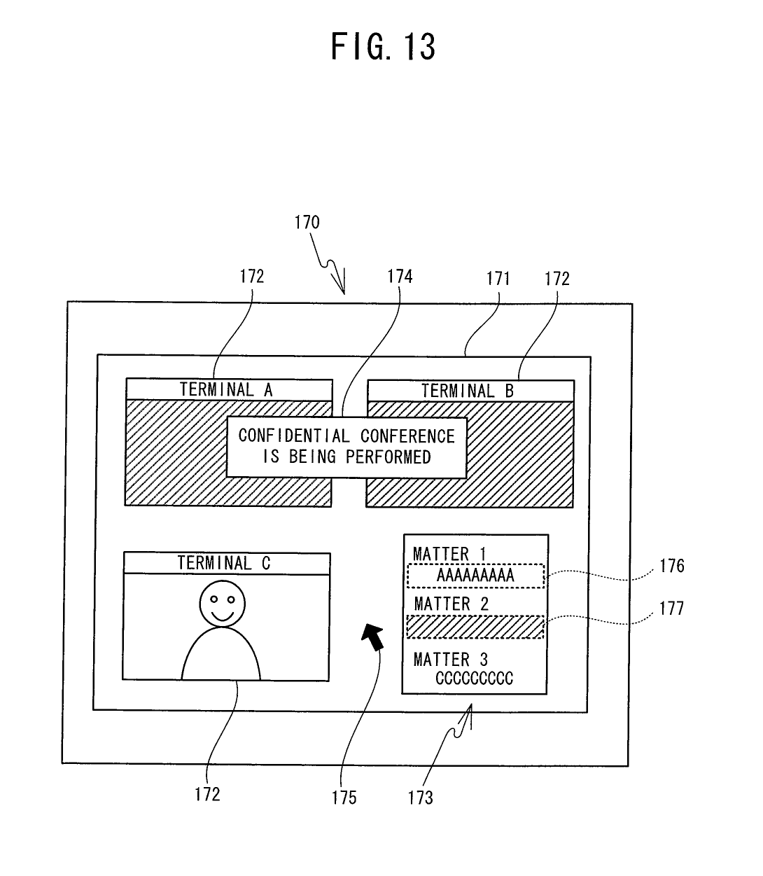

If the CPU 101 determines that the received data cannot be decrypted (NO at step S64), namely, if the decryption level of the decryption information acquired in the processing at step S63 is lower than the encryption level included in the received data, confidential conference information 174 is displayed on the video conference screen 171 as shown in FIG. 13 (step S67). The confidential conference information 174 is a message indicating that a confidential conference is being performed. At this time, an individual area 172 that corresponds to the terminal device 100 that has transmitted the encrypted data is changed to a non-display state. Then, the processing shifts to step S61. The video conference screen 171 shown in FIG. 13 is the video conference screen 171 of the terminal device 100 identified by the terminal ID “Terminal C”, and shows a state in which the confidential conference is being performed between the terminal device 100s identified by the terminal IDs “Terminal A” and “Terminal B”. Thus, it is possible to know that the confidential conference is being performed between the other terminal devices 100.

If the CPU 101 determines that the received data is not encrypted data (NO at step S62), namely, if the encryption information is not stored in the encryption information storage area of the RAM 103, the CPU 101 causes the received audio data or video data to be output as they are (step S66). The audio data may be output from the speaker 160 of the terminal device 100. The video data may be displayed on the individual area 172 that corresponds to the terminal device 100 that has transmitted the video data. Then, the processing shifts to step S61.

As described above, in the present embodiment, in a case where a video conference is performed and the mouse cursor for the terminal device 100 is moved to one of the confidential areas 176 and 177 within the shared display area 173 in which the shared data is displayed, the encryption information may be acquired that was used for encrypting the one of the confidential areas 176 and 177 in which the pointer is located. In a case where the decryption level of the decryption information acquired by the terminal device 100 from the server 200 is equal to or higher than the encryption level of the encryption information of one of the confidential areas 176 and 177, the confidential conference notification and the encryption information may be transmitted to the other terminal devices 100. The terminal device 100 that has received the confidential conference notification and the encryption information may encrypt audio data or video data based on the received encryption information, and may transmit the encrypted audio data or video data to the other terminal devices 100. The terminal device 100 that has received the encrypted audio data or video data may decrypt the received data and output the decrypted data, if the encrypted audio data or video data can be decrypted using the decryption information stored in the terminal device 100. Thus, the confidential conference may be performed in the video conference. As a result, in a case where the decryption level of the terminal device 100 is equal to or higher than the encryption level used when the confidential data was encrypted, it is possible to perform the confidential conference with the other terminal devices 100, by moving the mouse 130, which is a pointing device of the terminal device 100, onto the confidential data. As a result, the confidential conference can be performed smoothly during the video conference.

In the above-described embodiment, the conference information table 2100 may be stored in the server 200. Based on the conference ID and the terminal ID transmitted from the terminal device 100 to the server 200, the terminal device 100 may receive from the server 200 the decryption information to be used in the video conference. However, the decryption information may be acquired in another method. For example, the user that has generated shared data may transmit the decryption information from the terminal device 100 used by the user to the other terminal devices 100. The terminal device 100 may store the conference information table 2100, and the terminal device 100 may transmit the decryption information to the other terminal devices 100 when the video conference is performed. Similarly, the shared data need not necessarily be stored in the server 200.

In the above-described embodiment, the confidential conference information 174, as shown in FIG. 13, may be displayed in the processing at step S67 of the data output processing (refer to FIG. 12). However, the confidential conference information 174 need not necessarily be displayed.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A terminal device capable of communication with a plurality of other terminal devices via a network, comprising:
a decryption information acquisition portion that acquires decryption information that is information to decrypt confidential data that is partially encrypted data in shared data, the shared data being data to be shared with the plurality of other terminal devices and being to be displayed on a display screen that displays information, the decryption information including a decryption level that is a level at which the confidential data can be decrypted and that is determined for each terminal device;
an encryption information acquisition portion that acquires encryption information including an encryption level in a case where a pointer position is located within a confidential area that is an area in which the confidential data is displayed, the encryption level being a level of encryption that has been used for encrypting the confidential data being displayed in the confidential area, and the pointer position being a position that is identified by position information of a pointer that is displayed on the display screen based on input information from a pointing device;
a first transmission portion that transmits the encryption information to the plurality of other terminal devices in a case where the decryption level of the decryption information that has been acquired by the decryption information acquisition portion is equal to or higher than the encryption level of the encryption information that has been acquired by the encryption information acquisition portion;
an encryption portion that, based on the encryption level of the encryption information, encrypts audio data and video data that have been input in a case where the pointer position is located within the confidential area; and
a second transmission portion that transmits, as encrypted data, the audio data and the video data that have been encrypted by the encryption portion to the plurality of other terminal devices.

2. The terminal device according to claim 1, wherein
in a case where encryption information is received from any one of the plurality of other terminal devices, the encryption portion encrypts the audio data and the video data that have been input, based on an encryption level of the encryption information that has been received.

3. The terminal device according to claim 1, further comprising:
a decryption portion that, in a case where encryption information and encrypted data are received from any one of the plurality of other terminal devices and the decryption level of the decryption information is equal to or higher than an encryption level of the encryption information that has been received, decrypts the encrypted data that has been received;
a display control portion that, in a case where data that has been decrypted by the decryption portion is video data, causes the video data to be displayed on the display screen; and
an audio output control portion that, in a case where data that has been decrypted by the decryption portion is audio data, causes an audio output portion to output the audio data.

4. The terminal device according to claim 3, wherein
in a case where the decryption level is lower than the encryption level, the display control portion causes confidential conversation information to be displayed on the display screen, the confidential conversation information being information indicating that conversation relating to the confidential data is being performed between at least two of the plurality of other terminal devices.

5. The terminal device according to claim 1, wherein
the decryption information acquisition portion acquires the decryption information, based on identification information of the terminal device, from a decryption information storage portion in which the decryption information and identification information identifying a plurality of terminal devices including the terminal device are stored in association with each other for every video conference that is to be performed with the plurality of other terminal devices via the network.

6. A computer program product stored on a non-transitory computer-readable medium, comprising instructions for causing a computer of a terminal device capable of communication with a plurality of other terminal devices via a network to execute the steps of:
acquiring decryption information that is information to decrypt confidential data that is partially encrypted data in shared data, the shared data being data to be shared with the plurality of other terminal devices and being to be displayed on a display screen that displays information, the decryption information including a decryption level that is a level at which the confidential data can be decrypted and that is determined for each terminal device;
acquiring encryption information including an encryption level in a case where a pointer position is located within a confidential area that is an area in which the confidential data is displayed, the encryption level being a level of encryption that has been used for encrypting the confidential data being displayed in the confidential area, and the pointer position being a position that is identified by position information of a pointer that is displayed on the display screen based on input information from a pointing device;
transmitting the encryption information to the plurality of other terminal devices in a case where the decryption level of the decryption information that has been acquired is equal to or higher than the encryption level of the encryption information that has been acquired;
encrypting, based on the encryption level of the encryption information, audio data and video data that have been input in a case where the pointer position is located within the confidential area; and
transmitting, as encrypted data, the audio data and the video data that have been encrypted to the plurality of other terminal devices.

7. The computer program product according to claim 6, wherein
in a case where encryption information is received from any one of the plurality of other terminal devices, the audio data and the video data that have been input are encrypted based on an encryption level of the encryption information that has been received.

8. The computer program product according to claim 6, wherein the computer program product further comprises instructions for causing the computer to execute the steps of:
decrypting encrypted data in a case where encryption information and the encrypted data are received from any one of the plurality of other terminal devices and the decryption level of the decryption information is equal to or higher than an encryption level of the encryption information that has been received;
causing video data to be displayed on the display screen in a case where data that has been decrypted is the video data; and
causing an audio output portion to output audio data in a case where data that has been decrypted is the audio data.

9. The computer program product according to claim 8, wherein the computer program product further comprises instructions for causing the computer to execute the step of:
causing confidential conversation information to be displayed on the display screen in a case where the decryption level is lower than the encryption level, the confidential conversation information being information indicating that conversation relating to the confidential data is being performed between at least two of the plurality of other terminal devices.

10. The computer program product according to claim 6, wherein
the decryption information is acquired based on identification information of the terminal device, from a decryption information storage portion in which the decryption information and identification information identifying a plurality of terminal devices including the terminal device are stored in association with each other for every video conference that is to be performed with the plurality of other terminal devices via the network.

11. A communication control method performed by a terminal device capable of communication with a plurality of other terminal devices via a network, the method comprising the steps of:
acquiring decryption information that is information to decrypt confidential data that is partially encrypted data in shared data, the shared data being data to be shared with the plurality of other terminal devices and being to be displayed on a display screen that displays information, the decryption information including a decryption level that is a level at which the confidential data can be decrypted and that is determined for each terminal device;
acquiring encryption information including an encryption level in a case where a pointer position is located within a confidential area that is an area in which the confidential data is displayed, the encryption level being a level of encryption that has been used for encrypting the confidential data being displayed in the confidential area, and the pointer position being a position that is identified by position information of a pointer that is displayed on the display screen based on input information from a pointing device;
transmitting the encryption information to the plurality of other terminal devices in a case where the decryption level of the decryption information that has been acquired is equal to or higher than the encryption level of the encryption information that has been acquired;
encrypting, based on the encryption level of the encryption information, audio data and video data that have been input in a case where the pointer position is located within the confidential area; and
transmitting, as encrypted data, the audio data and the video data that have been encrypted to the plurality of other terminal devices.

12. The method according to claim 11, wherein
in a case where encryption information is received from any one of the plurality of other terminal devices, the audio data and the video data that have been input are encrypted based on an encryption level of the encryption information that has been received.

13. The method according to claim 11, further comprising the steps of:
decrypting encrypted data in a case where encryption information and the encrypted data are received from any one of the plurality of other terminal devices and the decryption level of the decryption information is equal to or higher than an encryption level of the encryption information that has been received;
causing video data to be displayed on the display screen in a case where data that has been decrypted is the video data; and
causing an audio output portion to output audio data in a case where data that has been decrypted is the audio data.

14. The method according to claim 13, further comprising the step of:
causing confidential conversation information to be displayed on the display screen in a case where the decryption level is lower than the encryption level, the confidential conversation information being information indicating that conversation relating to the confidential data is being performed between at least two of the plurality of other terminal devices.

15. The method according to claim 11, wherein
the decryption information is acquired based on identification information of the terminal device, from a decryption information storage portion in which the decryption information and identification information identifying a plurality of terminal devices including the terminal device are stored in association with each other for every video conference that is to be performed with the plurality of other terminal devices via the network.
